(19) United States
(12) Patent Application Publication
(10) Pub. No.: US 2006/0233982 A1
(43) Pub. Date: Oct. 19, 2006

(54) Multilayer food packaging

(75) Inventors: David Jaeger, Kenosha, WI (US); Jerry Gasner, Pleasant Prairie, WI (US)

Correspondence Address: FOLEY & LARDNER LLP, 777 EAST WISCONSIN AVENUE, MILWAUKEE, WI, 53202-5306, US

(73) Assignee: Vista International Packaging, LLC

(21) Appl. No.: 11/106,097

(22) Filed: Apr. 14, 2005

(51) Int. Cl. A22C 13/00

(52) U.S. Cl. 428/34.8

(57) ABSTRACT

A food casing includes an outer barrier layer, and an inner absorbent layer formed as a separate body from the outer barrier layer wherein the outer barrier layer and the inner absorbent layer are in frictional contact. Another food casing includes an outer barrier layer, and an inner absorbent layer formed as a separate body from the outer barrier layer wherein the outer barrier layer and the inner absorbent layer are not physically connected. A method for forming a food casing includes wrapping an outer barrier layer around an inner absorbent layer and sealing the outer barrier layer along a seam. The inner absorbent layer and the outer barrier layer of the resulting food casing are in frictional contact.

### BACKGROUND

The present invention relates generally to the field of food packaging and in particular to casings for meat and cheese products.

Meat products such as sausage, ham, turkey, and other meat products are often cooked and/or smoked in casings. Traditionally, smoking is performed by exposing the product to moderate heat in a smoke-filled chamber. The product is cooked and absorbs colors and/or flavors from the smoke. In large scale production, however, the traditional method of smoking is time consuming and expensive. As a result, many large scale producers cook their meat products in casings impregnated with flavors, colors, or both. This allows the meat to absorb the flavors and/or colors while lowering the total processing time and cost.

Fibrous casings that can be treated with additives such as, caramel color, liquid smoke, flavors, or other additives that may be used for producing smoked meat products. One such casing is a cellulose casing that has been treated with viscose and passed trough an acid bath. These casings absorb flavor and color additives well and transfer the additives to the meat during cooking. However, fibrous casings are permeable to water which results in a loss of weight during cooking.

Plastic casings have also been used. These casings are impermeable to water and prevent weight loss, but they do not absorb and transfer flavors and colors to the food product well. Other casings have been developed that attempt to provide adequate additive absorption while serving as a barrier to water and/or oxygen. One such casing includes a fibrous inner layer that is laminated with a barrier layer. The resulting film is rolled into a tube to form a casing with a longitudinal seam. These casings have several drawbacks. First, these casings are often sealed with tape placed over the seam because the laminated absorbent layer may hinder heat sealing along the seam. This may result in a weaker seal that can break. Also, during cooking or other processing, the layers can become delaminated at various points. Lastly, these casings may result in purge whereby liquid in the food product is lost.

Accordingly, there is a need for a food casing which is absorbent and transfers flavor and/or color to the food product well, while lessening water loss during cooking.

There is also a need for an absorbent casing that is thin enough to conserve flavor and/or color additives, while remaining strong enough to contain the food product during processing.

### SUMMARY

One embodiment relates to a food casing comprising an outer barrier layer, and an inner absorbent layer formed as a separate body from the outer barrier layer wherein the outer barrier layer and the inner absorbent layer are in frictional contact.

Another embodiment relates to a food casing comprising an inner absorbent layer; and an outer barrier layer wrapped about the inner absorbent layer wherein the inner absorbent layer and outer barrier layer are formed as separate bodies, and wherein the outer barrier layer and the inner absorbent layer are not physically connected.

Another embodiment relates to a method for forming a food casing comprising wrapping an outer barrier layer around an inner absorbent layer; and sealing the outer barrier layer along a seam. The inner absorbent layer and the outer barrier layer of the resulting food casing are in frictional contact.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of a multilayered food casing.

FIG. 2 is a schematic view of a system for forming a multilayered food casing.

FIG. 3 is a perspective view of a portion of the system of FIG. 2.

### DETAILED DESCRIPTION

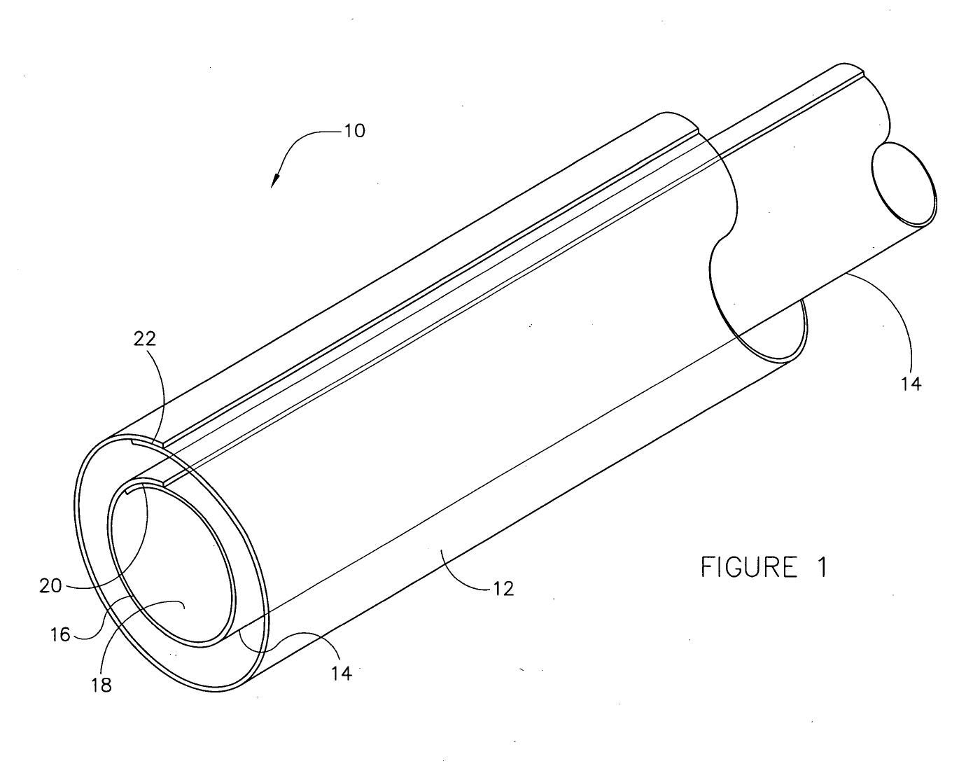

Referring to FIG. 1, a multilayer food casing 10 includes an outer layer 12 and an inner layer 14. The outer layer 12 may be a barrier layer that is impermeable to steam, oxygen, or both. As used herein, the term “impermeable” means not only wholly impassible, but also sufficiently impassible to achieve a desired result. For example, a layer that is impermeable to water is sufficiently impassible to liquid water and/or steam so as to lessen the amount of weight loss of a food item that would occur if the food item were prepared without the layer. Similarly, a layer that is impermeable to oxygen is sufficiently impassible to oxygen so as to lengthen the shelf life of a food item beyond the shelf life the food item would have if the food item were prepared without the layer. The outer layer 12 and inner layer 14 are separate bodies from each other in that no adhesives or other materials are used to connect or join the outer layer 12 to the inner layer 14.

The outer layer 12 may be a polymeric film made of one or more layers. According to an exemplary embodiment, the outer layer may be a three-layer film including a layer of polyamide material, such as a nylon, between two polyolefin layers, such as polyethylene. Alternatively, the outer layer may comprise a film with up to 5 layers. According to other embodiments, the outer layer may be made of polymeric materials that are shrinkable. Also, the outer layer may be sealable. The outer layer may be colored or clear. The outer layer may also be transparent, translucent, or opaque.

Inner layer 14 includes an inner surface 16, defining an inner volume 18 for receiving a foodstuff. Inner layer 14 may be absorbent so that it may be impregnated with an amount of flavor and/or color additive sufficient to flavor and/or color the foodstuff. Inner layer 14 may comprise cellulose, regenerated cellulose, viscose, fabric, fleece, paper, sponge and mixtures thereof. In one embodiment the inner layer is a fibrous sheet that comprises cellulose, regenerated cellulose, plasticizer and water that is formed from cellulose fibers that have been treated with viscose and passed through an acid bath to provide a smooth fibrous sheet. The sheet is then rolled into a tube and sealed along the longitudinal edges of the sheet to form seam 20. One such fibrous casing is the VISKO product available from OY Visko AB of Hanko, Finland. The term tube, as used herein, is not limited to an elongated shape with a circular cross-section. A tube may have any suitable cross-section including, but not limited to, circular, oval, rectangular, square, polygonal, or curvilinear. Also, the cross-section may vary along the length of the multilayered food casing.

Outer layer 12 may be wrapped around inner layer 14 and sealed along a seam 22 to provide the multilayer food casing. Outer layer 12 may be sealed along seam 22 in a variety of ways including heat sealing, ultrasonic sealing, infrared sealing, laser sealing, by use of adhesive or tape.

Multilayered food casing 10 may be stuffed or filled in a variety of conventional ways. Multilayered food casing 10 may be used to package a variety of foodstuffs for smoking, curing, boiling, or other processes. Multilayered food casing 10 is particularly well suited to meat and cheese products. However, it is understood that other foodstuffs may be used with the multilayered food casing. When the multilayered food casing is filled with a foodstuff, inner layer 14 is pressed against outer layer 12 such that the two layers do not move relative to one another due to friction. No adhesives or other joining means for physically connecting outer layer 12 and inner layer 14 and holding the layers in positions relative to one another are required. Ends of multilayered food casing 10 may be tied, crimped, sealed, or otherwise closed by a variety of means known in the art after stuffing multilayered food casing 10 with a foodstuff.

The multilayered food casing may be peeled or otherwise removed from the processed foodstuff. The outer layer may be removed first, followed by the inner layer, or the inner layer may be peeled such that both layers are removed at the same time.

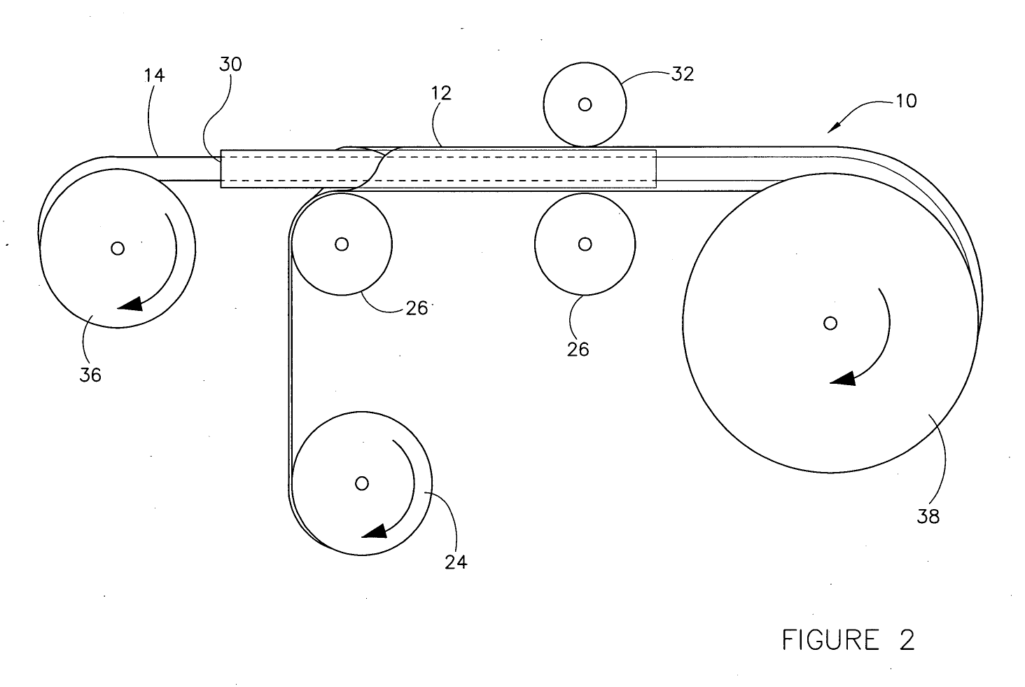

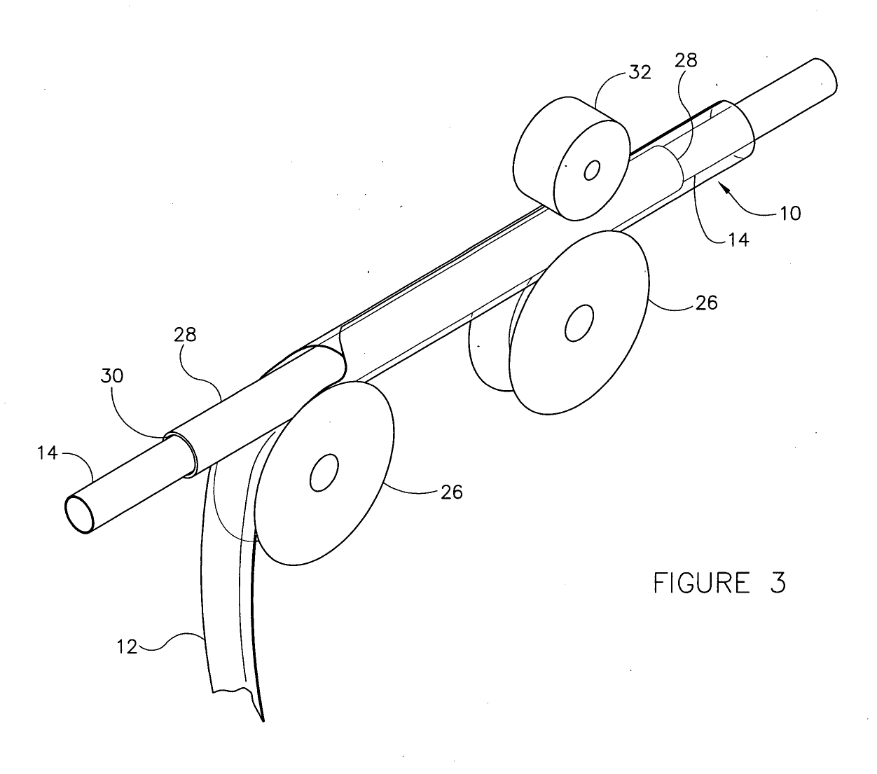

Referring to FIGS. 2 and 3, a system for manufacturing a multilayered food casing 10 is shown. According to one embodiment, the outer layer 12 is a flat polymeric film which is provided as a long sheet on a supply roll 24. The flat polymeric film is drawn from supply roll 24 and passed over guide wheel 26 to a forming shoulder 28 which includes channel 30. Outer layer 12 is wrapped around forming shoulder 28 to form the flat polymeric film into a tube where the edges of the sheet are overlapping. The edges of the polymeric film are passed through a sealing unit 32. Such a sealing unit may include a heated wheel that is in a fixed location relative to forming shoulder 28. According to one embodiment, the seam of the tube formed from the polymeric sheet passes between the heated wheel and the forming shoulder. The heated wheel fuses the edges of the sheet together to provide a seal along the seam. The seam is then air cooled to set the seal. Alternatively, other sealing devices may be used.

As outer layer 12 passes over forming shoulder 28, inner layer 14 is drawn from a second supply roll 36 and passed through channel 30 in forming shoulder 28 at about the same linear rate that the outer layer 12 passes over the outside of forming shoulder 28. Inner layer 14 comes into frictional contact with outer layer 12. The two layers are drawn together to a product roll 38.

The inner absorbent layer may be treated with flavors and/or colors (including, but not limited to, caramel color, liquid smoke, fruit flavors, other flavorings, or other additives) either before outer layer 12 is wrapped around inner layer 14, or after the multilayered food casing 10 has been formed. After the multilayered food casing has been formed, it may be wound onto product roll 38 and may then be transferred to a shirring process. Alternatively, the multilayered food casing may be transferred from the forming shoulder to a shirring process without being wound on a product roll.

The multilayered food casing may be shirred according to any conventional shirring process. According to an exemplary embodiment, the multilayered food casing may be shirred using an axial process. In such a process, the multilayered food casing is passed through pinch rollers and pulled onto a mandrel. A portion of the multilayered food casing between the mandrel and the pinch rollers is inflated with air or other gas supplied by a source passed through the mandrel. The inflated casing is pulled onto the mandrel by paddles mounted on rotating wheels or similar devices. The shirred casing may then be cut into segments and the ends tied, crimped or otherwise closed.

While the detailed drawings and specific examples given herein describe various exemplary embodiments, they serve the purpose of illustration only. It is to be understood that the invention is not limited in its application to the details of construction and the arrangements of components set forth in the preceding description or illustrated in the drawings.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A food casing comprising:
an inner absorbent layer; and
an outer barrier layer wrapped about the inner absorbent layer;
wherein the inner absorbent layer and outer barrier layer are formed as separate bodies, and wherein the outer barrier layer and the inner absorbent layer are in frictional contact.

2. The food casing of claim 1, wherein the inner absorbent layer includes an additive selected from the group consisting of flavors, colors, and mixtures thereof.

3. The food casing of claim 1, wherein the outer barrier layer is impermeable to water.

4. The food casing of claim 1, wherein the outer barrier layer is impermeable to oxygen.

5. The food casing of claim 1, wherein the outer barrier layer comprises a plastic film.

6. The food casing of claim 5, wherein the plastic film comprises a first polyolefin layer, a second polyolefin layer, and a first polyamide layer located between the first polyolefin layer and the second polyolefin layer.

7. The food casing of claim 6, wherein the plastic film further comprises a third polyolefin layer and a second polyamide layer located between the second polyolefin layer and the third polyolefin layer.

8. The food casing of claim 6, wherein the first polyolefin layer and the second polyolefin layer comprise polyethylene, and the polyamide layer is a nylon.

9. The food casing of claim 1, wherein the inner absorbent layer comprises a fibrous material selected from the group consisting of cellulose, regenerated cellulose, viscose, fabric, fleece, and mixtures thereof.

10. The food casing of claim 9, wherein the inner absorbent layer comprises a fibrous material selected from the group consisting of cellulose, regenerated cellulose, viscose and mixtures thereof.

11. The food casing of claim 1, wherein the casing is in the form of a tube.

12. A food casing comprising:
an inner absorbent layer; and
an outer barrier layer wrapped about the inner absorbent layer;
wherein the inner absorbent layer and outer barrier layer are formed as separate bodies, and wherein the outer barrier layer and the inner absorbent layer are not physically connected.

13. A method for forming a food casing comprising:
wrapping an outer barrier layer around an inner absorbent layer; and
sealing the outer barrier layer along a seam;
wherein the inner absorbent layer and the outer barrier layer of the resulting food casing are not physically connected.

14. The method of claim 13, further comprising treating the absorbent inner layer with an additive selected from the group consisting of flavors, colors, and mixtures thereof.

15. The method of claim 14, wherein the inner absorbent layer is treated with the additive before wrapping the outer barrier layer around the inner absorbent layer.

16. The method of claim 13, further comprising wrapping the food casing to form a roll.

17. The method of claim 13, further comprising shirring the food casing onto a mandrel.

18. The method of claim 17, further comprising cutting the food casing into segments, and sealing an end of the segment.

19. The method of claim 13, wherein wrapping an outer barrier layer around an inner absorbent layer includes passing the inner absorbent layer through a forming shoulder while passing the outer barrier layer over the forming shoulder.

20. The method of claim 13, further comprising adding additives selected from the group consisting of flavors, colors, or mixtures thereof to the food casing.
